(19) United States
(12) Patent Application Publication
(10) Pub. No.: US 2013/0311251 A1
(43) Pub. Date: Nov. 21, 2013

(54) System and Method for Presenting Advertisements in Conjunction with Presentation of a Bill

(71) Applicant: Justin R. Gibson, Long Beach, CA (US)

(72) Inventor: Justin R. Gibson, Long Beach, CA (US)

(21) Appl. No.: 13/473,386

(22) Filed: May 16, 2012

(51) Int. Cl. G06Q 30/02

(52) U.S. Cl. 705/14.4

(57) ABSTRACT

A system comprises an electronic display. A media processor is configured to present information at least comprising an advertisement for an establishment on the electronic display to a patron of the establishment. A power source is operable to supply an operating power to at least the electronic display and the media processor. A check presenter is configured to at least retain the electronic display and a check or bill from the establishment to the patron in which the advertisement is presented on the electronic display to the patron.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to advertisement systems. More particularly, the invention relates to a system for presenting advertisements in conjunction with presentation of a bill for goods and/or services.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

A customer receiving a bill in exchange for goods and services may be presented a device for securing the bill, credit card and other associated items. The device may include printed advertisements and other associated printed information in order to entice the customer to purchase additional goods or services.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an example system, in accordance with an embodiment of the present invention;

FIG. 2A illustrates an example system enclosure in a closed configuration, in accordance with an embodiment of the present invention;

FIG. 2B illustrates an example system enclosure in an open configuration, in accordance with an embodiment of the present invention;

FIG. 2C illustrates example system enclosure in an open configuration presenting locations of components, in accordance with an embodiment of the present invention;

FIG. 3 illustrates an example docking system, in accordance with an embodiment of the present invention;

FIG. 4 presents a picture of an example system enclosure in a semi-open configuration, in accordance with an embodiment of the present invention;

FIG. 5 presents a picture for a multiplicity of example system enclosures connected to a docking system, in accordance with an embodiment of the present invention;

FIG. 6 presents a picture for an example open system enclosure and a closed system enclosure, in accordance with an embodiment of the present invention;

FIGS. 7A-C illustrates an example method for operation of a system as described with reference to FIG. 1, in accordance with an embodiment of the present invention; and

FIG. 8 illustrates a computing system that, when appropriately configured or designed, may serve as a computing system for which the present invention may be embodied.

Unless otherwise indicated illustrations in the figures are not necessarily drawn to scale.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention will be described which provides means and methods for providing a system for receiving, processing and presenting advertisement information. System presents advertisement information via Graphical User Interfaces (GUIs) or via GUIs and via audible speakers. System performs charging/recharging of internal power supply. System receives and updates advertisement information via docking ports and/or wirelessly. In some embodiments system adjusts brightness of GUIs based upon ambient lighting conditions. In some embodiments system adjusts audio based upon ambient noise conditions. In some embodiments system detects and notifies when device has traversed acceptable geographic boundary. In some embodiments system detects close proximity to another device and mutes audio. In some embodiments system detects when to present information based upon location/orientation information and based upon button selections. In some embodiments system detects selection of a mute button and mutes presented audio accordingly. In some embodiments system detects a condition of low power and presents an indication accordingly. In some embodiments system provides mechanisms for preventing debris from contaminating connectors associated with connecting device to docking system.

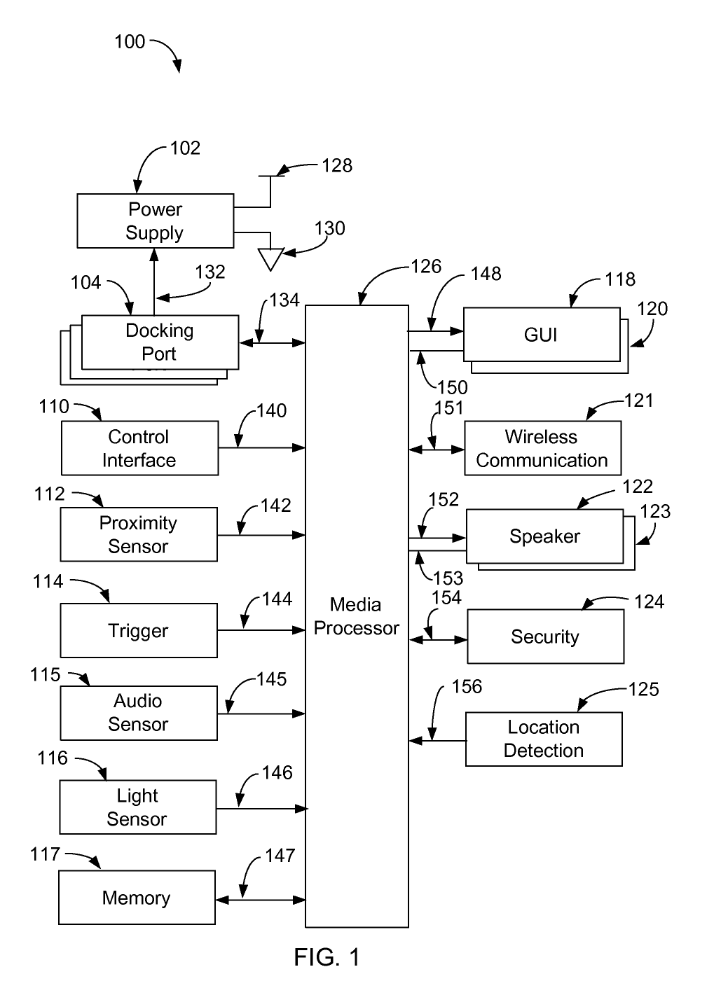

FIG. 1 illustrates an example system, in accordance with an embodiment of the present invention.

A system 100 includes a power supply portion 102, a multiplicity of docking ports with a sampling denoted as a docking port portion 104, a control interface portion 110, a proximity sensor portion 112, a trigger portion 114, an audio sensor portion 115, a light sensor portion 116, a memory portion 117, a GUI portion 118, a GUI portion 120, a wireless communication portion 121, a speaker portion 122, a speaker portion 123, a security portion 124, a location detection portion 125 and a media processor portion 126.

Power supply portion 102 is arranged to provide a positive voltage source 128 and a ground potential 130.

Power supply portion 102 is arranged to receive power from docking port portion 104 via a power supply signal 132.

Media processor portion 126 is arranged to communicate bi-directionally with docking port portion 104 via a communication channel 134.

Media processor portion 126 is arranged to receive information from control interface portion 110 via a communication channel 140.

Media processor portion 126 is arranged to receive information from proximity sensor portion 112 via a communication channel 142.

Media processor portion 126 is arranged to receive information from trigger portion 114 via a communication channel 144.

Media processor portion 126 is arranged to receive information from audio sensor portion 115 via a communication channel 145.

Media processor portion 126 is arranged to receive information from light sensor portion 116 via a communication channel 146.

Memory portion 117 is arranged to communicate bi-directionally with media processor portion 126 via a communication channel 147.

GUI portion 118 is arranged to receive information from media processor portion 126 via a communication channel 148.

GUI portion 120 is arranged to receive information from media processor portion 126 via a communication channel 150.

Media processor portion 126 is arranged to communicate bi-directionally with wireless communication portion 121 via a communication channel 151.

Speaker portion 122 is arranged to receive information from media processor portion 126 via a communication channel 152.

Speaker portion 123 is arranged to receive information from media processor portion 126 via a communication channel 153.

Media processor portion 126 is arranged to communicate bi-directionally with security portion 124 via a communication channel 154.

Media processor portion 126 is arranged to receive information from location detection portion 125 via a communication channel 156.

System 100 provides an interactive interface for a customer paying a bill associated with a retail establishment. For example, a customer may receive his bill in a device incorporating system 100 and may view and interact with system 100.

Power supply portion 102 provides power to control interface portion 110, proximity sensor portion 112, trigger portion 114, audio sensor portion 115, light sensor portion 116, GUI portion 118, wireless communication portion 121 and security portion 124. Power supply portion 102 provides electrical power such that system 100 may be transported from location-to-location (e.g. table-to-table, station-to-station, etc.) without requiring an external connection for general operation. As a non-limiting example, power supply portion 102 may be configured as a replaceable battery or a rechargeable battery.

Docking port portion 104 provides an interface to external entities for communicating with media processor portion 126 and for charging/recharging power supply portion 102. For example, a user may connect a computing device to docking port portion 104 in order to configure system 100 and charge/recharge power supply portion 102.

Control interface portion 110 provides selection devices in order for a user to control the operation of system 100. For example, a user may select to mute audio being provided via speaker portion 123 via a button associated with control interface portion 110. Control interface portion 110 may include a touch screen or button for enabling a customer to select the content to be presented.

Control interface portion 110 may include a button for initiating presentation of information. For example, a waiter/waitress may push a button for initiating presentation when delivering a bill to a customer.

Proximity sensor portion 112 provides location information regarding other devices. For example, proximity sensor portion 112 may communicate the detection of another proximity sensor associated with another system. Furthermore, as a result of detecting another proximity sensor portion associated with another device, system 100 may mute its audio in order to prevent simultaneous playing of audio. Furthermore, a single system may be muted or multiple systems may be muted as a result of being within close proximity. Furthermore, system 100 and an external system in close proximity may select to synchronize and transmit audio in a simultaneous manner.

Trigger portion 114 provides detection for placement/orientation of system 100. For example, trigger portion 114 may detect the placement of system 100 onto a flat table surface (e.g. table). As an example, trigger portion 114 may communicate an event to media processor portion 126 following a certain time period of being placed on a table/bar which indicates system 100 is to start presenting information via the GUI(s). Trigger portion 114 may consider a multiplicity of factors for determining when to signal presentation of information. Non-limiting examples for factors for determining when to signal presentation of information include audio level, infrared (e.g. body heat) and motion. In an alternate embodiment, the table/bar may comprise a sensor that detects the presence of system 100 and interacts with trigger portion 114 to start the presentation. Furthermore, trigger portion 114 may communicate an event to cease presenting information to media processor portion 126.

Audio sensor portion 115 provides detection of ambient audio. Based upon the level of audio detected by audio sensor portion 115 and communicated to media processor portion 126, media processor portion 126 may adjust the volume of the audio information presented via speaker portion 122 and/or speaker portion 123. For example, in a quiet location, media processor portion 126 may adjust the presentation of audio via speaker portion 122 and/or speaker portion 123 to a low level. Furthermore, in a loud location, media processor portion 126 may adjust the presentation of audio via speaker portion 122 and/or speaker portion 123 to a high level.

Light sensor portion 116 provides detection of ambient light. For example, the illumination intensity of GUI portion 118 may be configured based upon the amount of ambient light received via light sensor portion 116. Furthermore, light sensor portion may decrease power consumption resulting in increased battery life. As an example, a system located in a dark restaurant may detect a condition of low light and decrease the intensity of the GUIs in order to prevent overly bright GUIs. Furthermore, a system located in a highly illuminated restaurant may increase the intensity of the GUIs in order for the presented information to be sufficiently viewed.

Memory portion 117 provides storage for information. For example, memory portion 117 may store instructional code or configuration information for media processor portion 126 and audio and video presentation content. As a non-limiting example, memory portion 117 may be configured as a memory card which may be removed and/or replaced.

GUI portion 118 and GUI portion 120 provide presentations for viewing by a viewer. For example a customer may view an advertisement presented via GUI portion 118 or GUI portion 120. Non-limiting examples for devices which may be configured for GUI portion 118 and GUI portion 120 include Liquid Crystal Display (LCD), Organic Light Emitting Diode (OLED) and Super-Twisted Nematic (STN) Display. As non-limiting examples, GUI portion 118 and GUI portion 120 may be configured for presenting electronic images, animated images or videos.

Wireless communication portion 121 provides wireless communication between system 100 and external entities. In some alternate embodiments, for example, a user may communicate with a bank or credit card company via wireless communication portion 121.

Wireless communication portion 121 may connect with wireless communication system in order for information to be presented via GUI portion 118 and/or GUI portion 120. Non-limiting examples of information communicated via wireless include images, videos, advertisement materials, instructional code and configuration information. Furthermore, advertisements may be uniquely configured for the customer. As a non-limiting example, an advertisement presented to a customer may be based upon the items the customer purchased or upon the method of payment selected by the customer. Additionally, system 100 may communicate what material the customer played and how the customer interacted with system 100.

Speaker portion 122 and speaker portion 123 provide audio information. For example, speaker portion 122 may provide audible instructions to a user.

Security portion 124 determines whether system 100 has traversed the boundaries of its acceptable geographic area. For example, system 100 traveling the beyond the front door of a retail establishment may sound an alarm indicating the crossing of an acceptable geographic boundary. Furthermore, system 100 may cease to operate when detecting the unit has traversed is acceptable border.

Media processor portion 126 provides processing for system 100. As a non-limiting example, media processor portion 126 may provide information to GUI portion 118 and GUI portion 120 for presentation of electronic images, animated images or videos. Furthermore, media processor portion 126 may provide audio information to speaker portion 122 and/or speaker portion 123.

In operation, power supply portion 102, containing batteries, may be charged/recharged via docking port portion 104 interfacing with a device capable of connecting with docking port portion 104. Instructional codes and configuration information maybe downloaded for storage in memory portion 117, or contents of memory portion 117 may be uploaded, via docking port portion 104 and/or via wireless communication portion 121. Light sensor portion 116 detects the intensity of ambient light and configures the intensity of GUI portion 118 accordingly. For example, for a brighter room, the intensity of GUI portion 118 may be configured for brighter illumination and vice-versa. System 100 may be configured via control interface portion 110. For example, device may be turned off, turned on, enabled for audio, muted for audio and configured for appropriate volume of audio via control interface portion 110. Alternately, system 100 may be controlled remotely. Device containing system 100 further containing information associated with a bill is presented to a customer. Trigger portion 114 detects placement of device on table and begins to present information via GUI portion 118 and speaker portion 123. Alternately, a sensor in a table/bar may detect the proximity of the device to begin presentation. Trigger portion 114 may detect an external device located near system 100 and communicate the information to media processor portion 126. Furthermore, media processor portion 126 may cease communicating audio information to speaker portion 123 in order to prevent overlapping audio from the two collocated devices. Location detection portion 125 detects the location of the device and communicates the information to media processor portion 126. Media processor portion 126 communicates received location information to security portion 124. Security portion compares current geographic location information with acceptable locations and if not acceptable communicates the traversing of boundary information to media processor portion 126. Media processor portion 126 receives boundary traverse information and communicates an alarm to be broadcast via speaker portion 123. Alternately, media processor portion 126 may disable functions of the device and communicate via wireless communication 121 for example, but not limited to, the traversing of the boundary, last use of the device, last possession of the device, etc. After customer has completed transaction, device may be returned to docking station for recharging and/or configuration.

System 100 provides an integrated electronic display (e.g. GUI portion 118 and GUI portion 120) and media processor portion 126 for presenting information via GUI portion 118 and GUI portion 120. Non-limiting examples for information presented via GUI portion 118 and GUI portion 120 include advertisements and other advertisement promotional material. As a non-limiting example, system 100 may provide functionality for a bill/check presentation conduit for delivery of bills/checks to customers.

Furthermore, system 100 is portable and may be transported to a customer (e.g. sitting at a table or bar).

System 100 provides advertisements, advertising promotional material and other messages to customers receiving a bill or check in response to delivery of goods and/or services. Advertisements may be provided via GUIs and via speakers.

Non-limiting examples for applications of system 100 include signage companies (e.g. companies distributing electronic advertisements), restaurants and business franchises.

System 100 may provide the capability for a customer to select approval or disapproval associated with information presented via GUIs and speakers. Furthermore, system 100 may communicate the approval/disapproval information to a docking station or other computing device for further processing.

In some embodiments, memory portion 117 and power supply portion 102 (e.g. battery) may be removed and/or replaced from system 100. Memory portion 117 may be removed for modifying, viewing and processing information stored via memory portion 117. Power supply portion 102 may be removed for recharging or may be removed and replaced by a different power supply component (e.g. battery). Furthermore, integrated memory and power supply may be configured as a clip device which may be inserted and secured into system 100 in a manner similar to a laptop computer or mobile device battery.

Furthermore, memory portion 117 and power supply portion 102 may be physically integrated together and may be removed from and replaced for system 100 as a single unit. Furthermore, the integrated version of memory portion 117 and power supply portion 102 may be inserted into a docking station for charging/recharging and for processing information associated with memory portion 117. Furthermore, integrated version of memory portion 117 and power supply portion 102 may be configured such that the combination of the integrated portion and the docking station portion may function as a computing device (e.g. laptop, notebook, mobile device, etc.).

System 100 may communicate with Point-of-Sale (POS) system associated with retail establishment via docking port portion 104 and/or wireless communication portion 121. Via POS, information associated with system 100 may be analyzed and used to play the desired media or advertisement to the customer. As a non-limiting example, trend analysis may be performed for information associated with system 100. System 100 may process and store information associated with customer purchases. Furthermore, advertisements presented via system 100 may be configured based upon customer purchases analyzed via the POS.

Communication may be performed between system 100 and a global network (e.g. Internet) via docking port portion 104 and wireless communication portion 121. Furthermore, system 100 may be configured and updated via a global network. Furthermore, information may be retrieved from system 100 via a global network. As a non-limiting example, an external computing device may analyze the frequency of various advertisements viewed by customers.

System 100 supports storage of partial download of information, as system 100 may be removed from docking station prior to completion of information download. Furthermore, system 100 does not use information associated with partial download of information. Furthermore, following reconnection of system 100 to docking device and following download of information system 100 may use downloaded information for presentation, configuration, etc. Furthermore, memory portion 117 may be segmented into to portions, one portion for partially downloaded information and one portion for information which has been successfully downloaded.

System 100 may power off when unit detects it is not being used. As a non-limiting example, system 100 may detect via location detection portion 125 non-use of the unit associated. Furthermore, system 100 may power down mode as a result of the unit not being moved for a period of time. Furthermore, system may detect a condition of power down via not opening/closing the device for a period of time.

System 100 may detect a low power supply condition (e.g. low battery) and present a low power supply indication. Non-limiting examples for low power supply indication include visual presentation via GUIs, audio presentation via speakers or other lights or signals.

FIG. 1 illustrates an example system for interfacing with a customer while customer is in the process of paying for a bill.

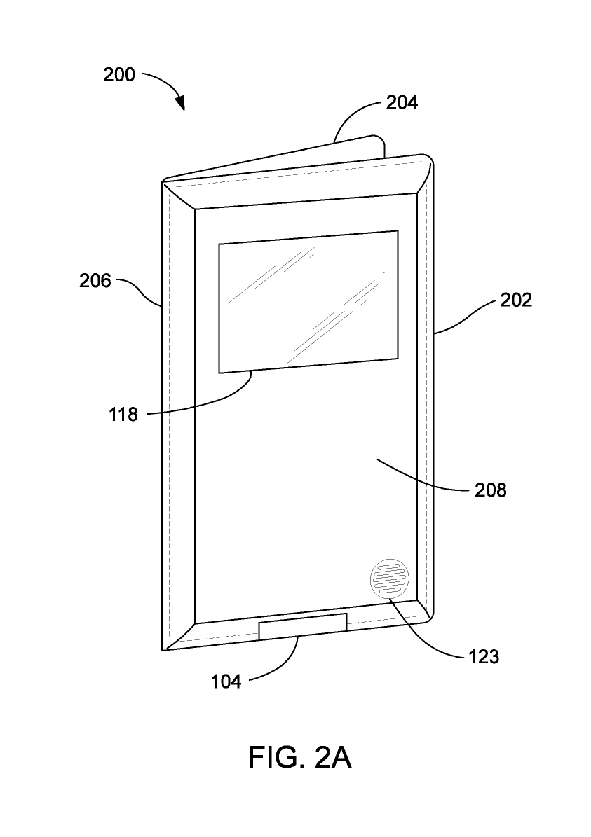

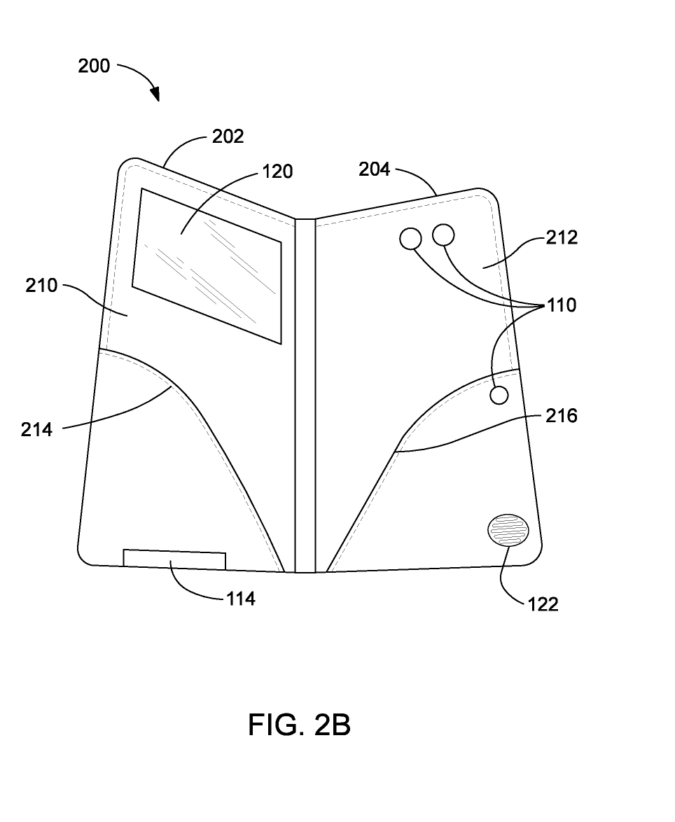

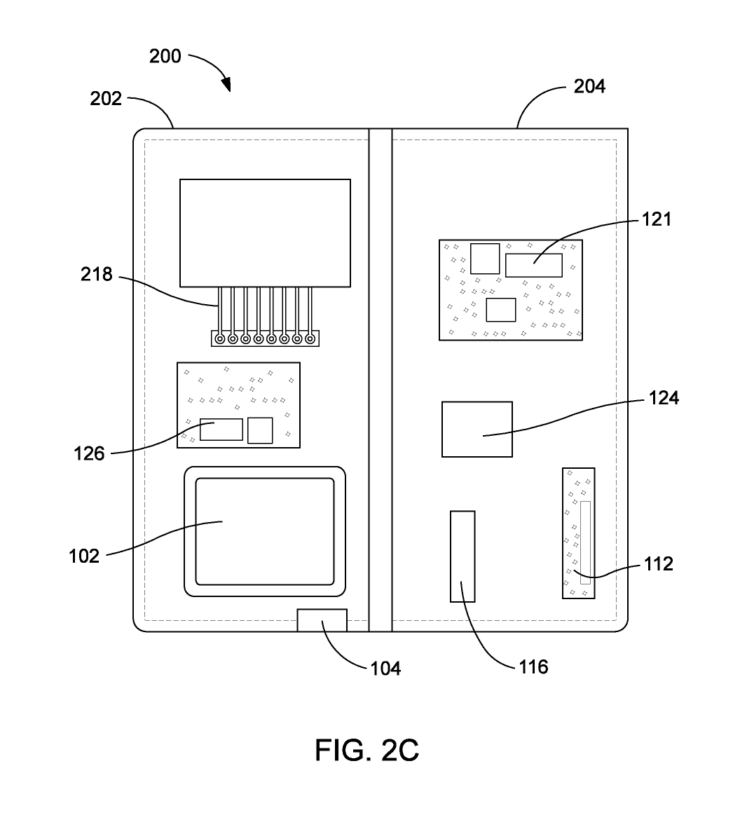

FIG. 2A illustrates an example system enclosure in a closed configuration, in accordance with an embodiment of the present invention.

A system enclosure 200 includes a front cover 202, a rear cover 204 and a hinge device 206.

System enclosure 200 provides an enclosure for system 100 as described with reference to FIG. 1 in order to provide an interface to a customer paying a bill.

Front cover 202 provides a covering for enclosing bill information and encapsulating portions of system 100. Front cover includes a front surface 208.

Rear cover 204 provides a covering for enclosing bill information and encapsulating portions of system 100.

Hinge device 206 joins front cover 202 and rear cover 204 and provides a mechanism for allowing front cover 202 and rear cover 204 to open or close.

GUI portion 118 described with reference to FIG. 1 may be configured for the upper portion of the front surface 208 of front cover 202 or any other surface of enclosure 200. Docking port portion 104 described with reference to FIG. 1 may be located in lower portion of front cover 202. Speaker portion 123 described with reference to FIG. 1 may be configured for the lower right of front surface 208.

System enclosure 200 provides two panels joined together via a flexible material or a hinge device. Furthermore, the two panels are configured in a manner similar to a book. GUI portion 118 is integrated such that it is visible to a customer when initially presented with the bill or when the enclosure is opened. GUI portion 118 may be of any size. GUI portion 118 may be configured for a portion of front cover 202 or configured for the entire area of front cover 202. Furthermore, GUI may be configured for front and/or rear panel and may be configured for any surface associated with the panels. Furthermore, an internal GUI is visible to the customer following the opening of system enclosure 200. The hinge device may be located on any edge of the associated panels. Furthermore, in some embodiments, system enclosure 200 may be configured with a single panel. GUI portion 118 is integrated into system enclosure 200 and is configured to present electronic information. Non-limiting examples for information presented include images, videos and advertisements.

GUI portion 118 is integrated into the body of system enclosure 200 for presenting information with or without associated audio. Audio may be provided via speaker portion 123.

FIG. 2A illustrates example system enclosure 200 in a closed configuration with a front cover, back cover, hinge device, GUI, docking port and speaker.

FIG. 2B illustrates an example system enclosure in an open configuration, in accordance with an embodiment of the present invention.

Front cover 202 includes an inside surface 210.

Rear cover 204 includes an inside surface 212.

Trigger portion 114 described with reference to FIG. 1 is configured for placement near the lower left portion of inside surface 210. Trigger portion 114 may be configured for placement in various other locations.

GUI portion 120 described with reference to FIG. 1 is configured for placement near the upper middle portion of inside surface 210.

A pocket portion 214 is configured for placement near the lower portion of inside surface 210. Pocket portion 214 provides a place for securing items. Non-limiting examples of items include bills and invoices.

Speaker portion 122 is configured for placement near the lower portion of inside surface 212.

A pocket portion 216 is configured for placement near the lower portion of inside surface 212. Pocket portion 216 provides a place for securing items. Non-limiting examples of items include bills and invoices.

Multiplicities of elements for control interface portion 110 are configured for placement near the top and middle right portions of inside surface 212. Non-limiting examples for control interface portion 110 include a mute button and direct access buttons. For example, mute button may operate to mute and un-mute speaker portion 122. A direct access button may activate presentation of a particular file, video, image, audio, etc. As a non-limiting example, a special offer may be presented that gets a discount on desert.

FIG. 2B illustrates an example system enclosure in an open configuration with GUI, pockets, buttons, trigger and speaker.

FIG. 2C illustrates example system enclosure 200 in an open configuration presenting locations of components, in accordance with an embodiment of the present invention.

GUI portion 120 is located in the upper portion of front cover 202.

A wire harness portion 218 is located in front cover 202 below GUI portion 120. Wire harness portion 218 enables connection of GUI portion 120 to other components.

Media processor portion 126 is located in front cover 202 below wire harness portion 218.

Power supply portion 102 is located in front cover 202 below media processor portion 126.

Docking port portion 104 is located in front cover 202 below power supply portion 102.

Wireless communication portion 121 is located in rear cover 204 near the top middle.

Security portion 124 is located in rear cover 204 near the middle.

Light sensor portion 116 is located in rear cover 204 near the lower left corner.

Proximity sensor portion 112 is located in rear cover 204 near the lower right corner.

System enclosure 200 includes an internal frame for securing electronic components. Non-limiting examples for materials associated with manufacture of the internal frame include acrylic and Polyvinyl Chloride (PVC).

System enclosure 200 is configured for modular installation and replacement of components, connectors, memory, battery, etc. Components are configured for low voltage, low power operation in order to provide longevity for the power supply. Furthermore, internal structure of system enclosure 200 is fabricated of flexible yet rigid materials for ease of installing components. Furthermore, system enclosure 200 is configured for operating in a harsh environment (e.g. restaurant).

FIG. 2C illustrates an example system enclosure in an open configuration with configuration for locations of GUI, wire harness, media processor, power supply, docking port, wireless communications, security, light detector and proximity sensor.

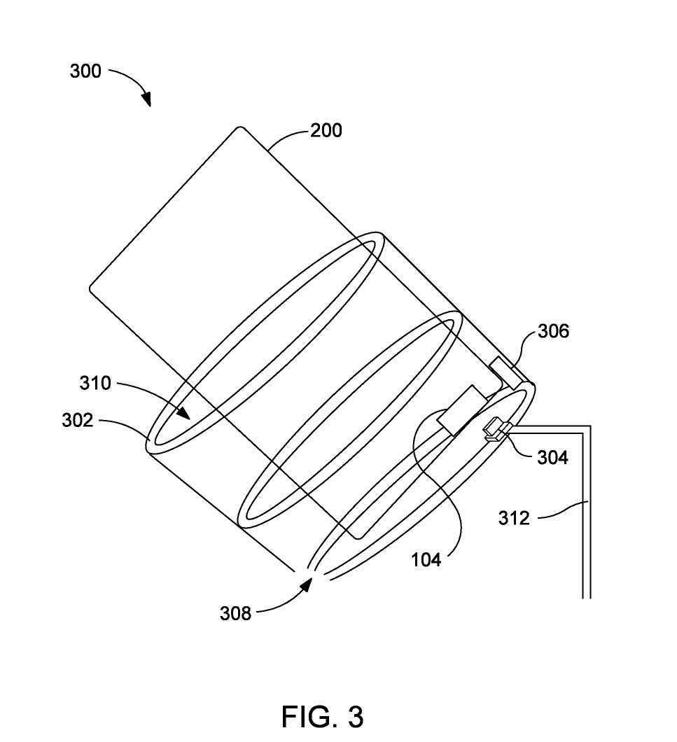

FIG. 3 illustrates an example docking system, in accordance with an embodiment of the present invention.

A docking system 300 includes an enclosure portion 302, a port connector 304, a connecting mechanism 306 and a debris opening 308.

Docking system 300 provides docking of system enclosure 200 in order to provide communications with system enclosure 200 and to provide charging/recharging of power system associated with system enclosure 200.

Enclosure portion 302 provides a support assembly for components interfacing with system enclosure 200.

Port connector 304 connects to docking port portion 104.

Connecting mechanism 306 provides alignment and support for inserting system enclosure 200 into enclosure portion 302. Connecting mechanism 306 is located on the docking system 300 and engages a cover on port 104 to open when sliding system enclosure 200 into the dock. The cover on port 104 is normally closed when not in the dock in order to protect from grim and food.

Debris opening 308 provides a conduit where debris attached to system enclosure 200 may be expelled.

An opening 310 provides an opening in order for system enclosure 200 to traverse into docking system 300.

A cable 312 provides a path for communication signals between components associated with system 100 of system enclosure 200 and external communication devices.

System enclosure 200 may be inserted into docking system 300 for charging/recharging. Furthermore, information may be updated when system enclosure 200 is inserted into docking system 300. Non-limiting examples for other information updates include images, video, advertisement material and instructional codes.

Port connector 304 and port 104 provide covers which open when system enclosure 200 into docking system 300. Furthermore, cover for port connector 304 and port 104 close when system enclosure 200 is removed from docking system 300. Opening and closing of covers for port connector 304 and port 104 is a result of connecting mechanism 306 being moved when system enclosure 200 is inserted into docking system 300 and when system enclosure 200 is removed from docking system 300. The covers provides protection for port connector 304 and port 104 when system enclosure 200 is not located within docking system 300.

Docking system 300 may be configured at an angle in order to reduce the possibility of debris contaminating port connector 304.

Debris opening 308 provides a conduit for contaminants to be expelled from system enclosure 200 and docking system 300.

Docking system 300 enables system enclosure 200 to be transported without continual connection to external electrical power. System enclosure 200 may be charged/recharged via docking system 300. Furthermore, system enclosure 200 may be updated with information (e.g. images, video, advertisements, etc.) via docking system 300. Some embodiments enable removal of power supply and memory card from system enclosure 200 for charging/recharging and information update.

Docking system 300 enables insertion of system enclosure 200 such that electrical connections between the devices remain free of contaminants.

System enclosure 200 includes a covering for the port connector that opens when inserted into docking system 300 and closes upon removal from docking system 300. The port covering provides protection for the connector and repulsion of contaminants when system enclosure 200 is not inserted into docking system 300 and enables connection to the docking station when system enclosure 200 is inserted into docking system 300. The covering includes a flap, seal and arm that provides an opening action when contacting docking system 300 and a closing action when not contacting docking system 300. In some embodiments protective covering may be manually opened and closed.

Docking system 300 enables easy insertion of system enclosure 200 for charging/recharging and information update. Docking system 300 may include a sliding mechanism for facilitating easy insertion. Some embodiments of docking system 300 support charging/recharging and information update for a multiplicity of system enclosure 200. Non-limiting examples for updating information include Universal Serial Bus (USB), wireless, infrared and memory card.

In other embodiments, system enclosure 200 may charged/recharged and/or updated via an interface cable.

FIG. 3 illustrates an example docking system where a system enclosure may be inserted for charging/recharging and communicating with components associated with system enclosure 200.

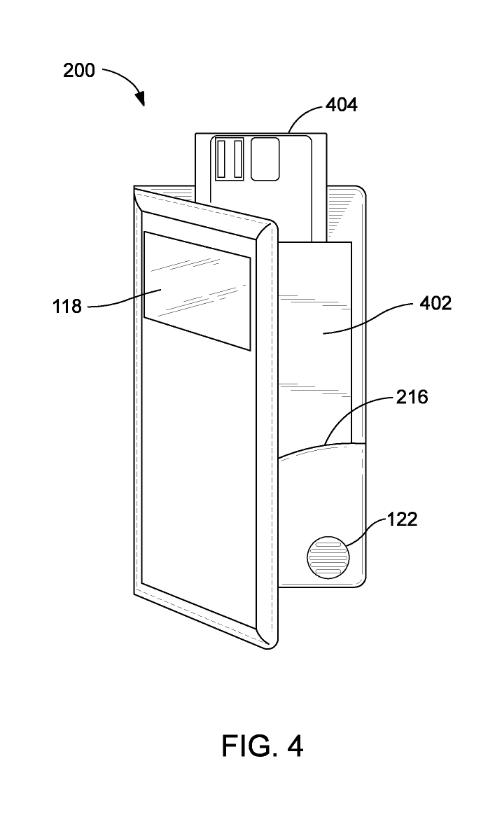

FIG. 4 presents a picture of an example system enclosure in a semi-open configuration, in accordance with an embodiment of the present invention.

GUI portion 118 presents an image or video for viewing by a customer. As a non-limiting example, image/video may be an advertisement.

Speaker portion 122 may provide audio to be listened to by a user. As a non-limiting example, audio may be presented in conjunction with image/video presented via GUI portion 118.

Pocket portion 216 secures a bill 402. For example, a restaurant customer may view a bill associated with a meal.

A credit card 404 may be affixed to system enclosure 200. For example, after receiving bill 402, customer may provide credit card 404 in order to pay for a meal.

FIG. 4 presents a picture of an example system enclosure in a semi-open configuration with an attached bill and credit card.

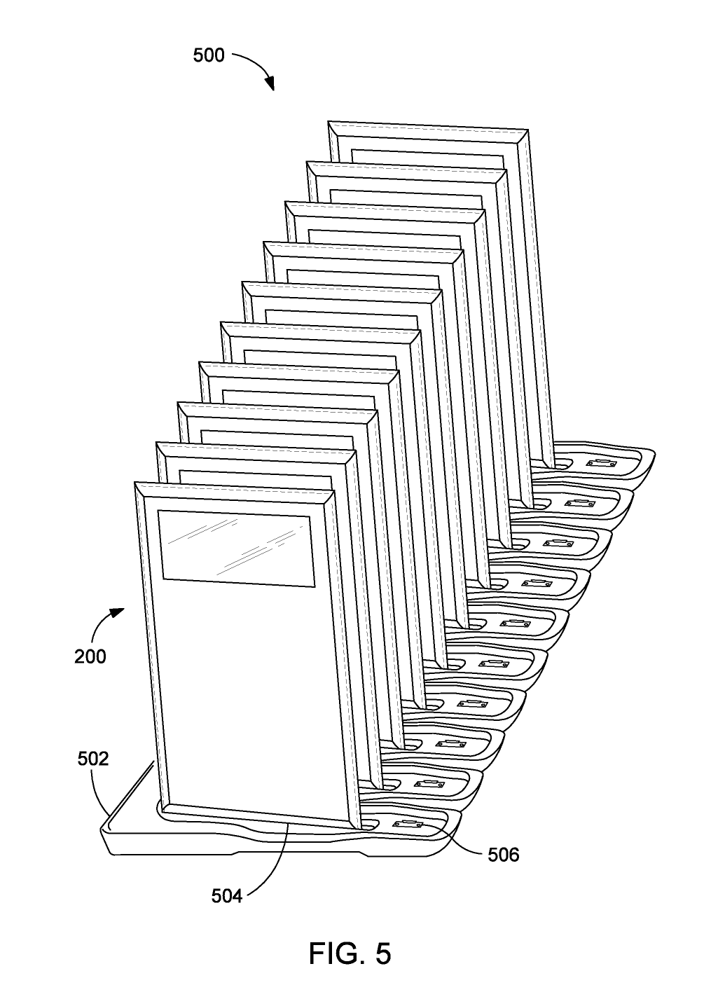

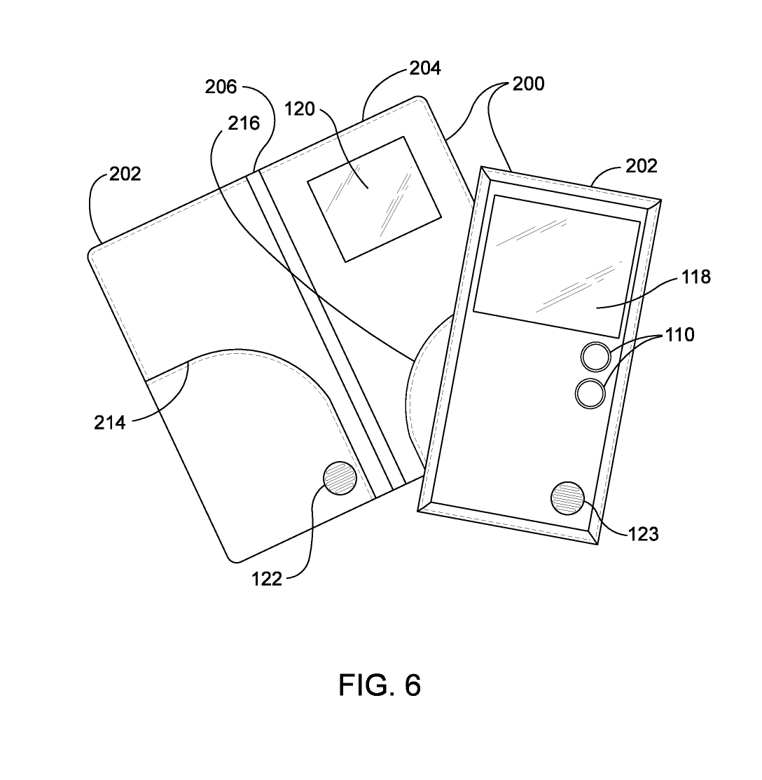

FIG. 5 presents a picture for a multiplicity of example system enclosures connected to a docking system, in accordance with an embodiment of the present invention.

A docking system 500 includes a docking enclosure 502, a multiplicity of docking slots with a sampling denoted as a docking slot 504 and a multiplicity of port connectors with a sampling denoted as a port connector 506.

Docking system 500 enables a multiplicity of system enclosures to be charged/recharged, configured and communicated with.

System enclosure 200 is inserted into docking slot 504.

A computing device may be connected to port connector 506 for charging/recharging, configuring and communicating with components associated with system enclosure 200.

FIG. 5 presents a picture for a multiplicity of example system enclosures connected to a docking system in order to provide for charging/recharging, configuring and communicating with system enclosures.

FIG. 6 presents a picture for an example open system enclosure and a closed system enclosure, in accordance with an embodiment of the present invention.

System enclosure 200 may be open and closed about hinge device 206 by application of force to front cover 202 and/or application of force to rear cover 204.

System enclosure 200 provides audio/video located internal (e.g. GUI portion 120 and speaker portion 122) to system enclosure 200 or located external (e.g. GUI portion 118 and speaker portion 123) to system enclosure 200.

Furthermore, system enclosure 200 may provide control interface portion 110 internal or external to system enclosure 200.

Bills may be secured to system enclosure 200 via pocket portion 214 and pocket portion 216.

FIG. 6 presents a picture for an example open system enclosure and a closed system enclosure, where system enclosure may be opened and closed via application of force to front cover and/or rear cover.

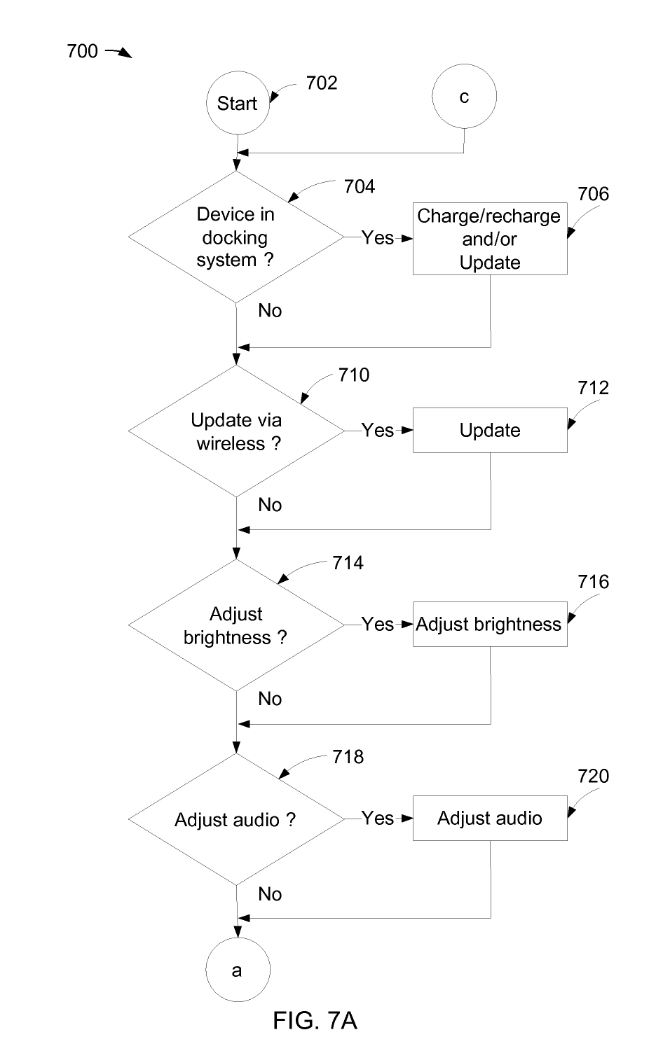

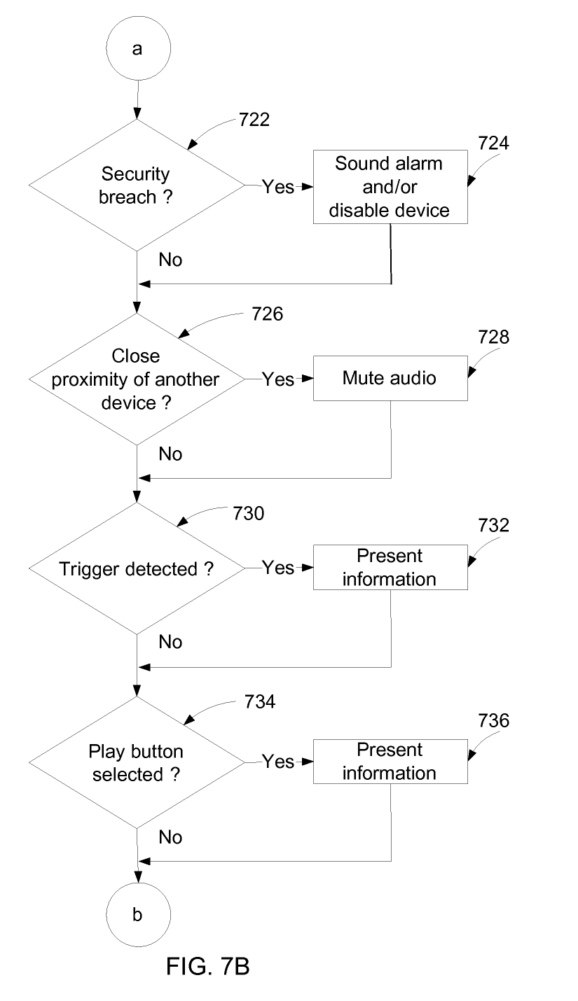

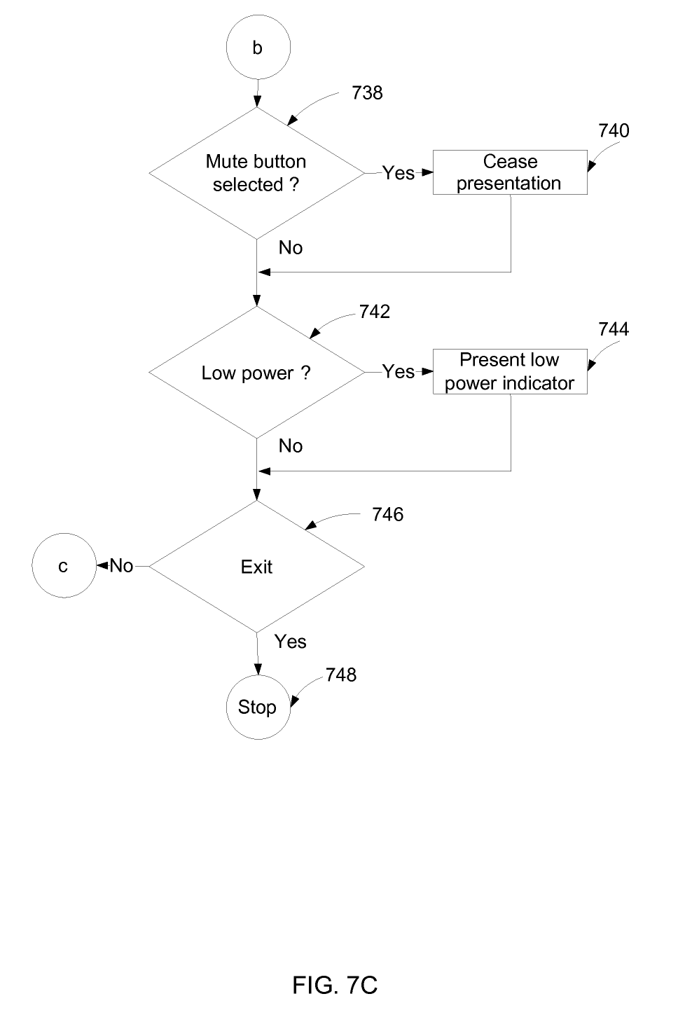

FIGS. 7A-C illustrates an example method for operation of system 100 as described with reference to FIG. 1, in accordance with an embodiment of the present invention.

A flow chart 700 initiates in a step 702.

A determination for insertion of system 100 (FIG. 1) into docking system 300 (FIG. 1) may be performed in a step 704.

Docking port portion 104 (FIG. 1) detects whether it is connected to an external entity for receiving power and performing communication.

Referring to FIG. 7A, then if it is determined system 100 (FIG. 1) is inserted into docking system in step 704, then in a step 706 system 100 (FIG. 1) is charged/recharged and updated.

Docking port portion 104 (FIG. 1) receives power from docking system 300 (FIG. 3) and transfers power to power supply portion 102 (FIG. 1) via power supply signal 132 (FIG. 1). As an example, batteries associated with power supply portion 102 (FIG. 1) are charged/recharged as a result of receiving power.

Docking port portion 104 (FIG. 1) receives information updates from docking system 300 (FIG. 1). Received information updates are communicated to media processor portion 126 (FIG. 1). Media processor portion 126 receives and processes update information and stores processed information in memory portion 117 (FIG. 1). As an example, advertisement updates may be received, processed and stored in memory for later retrieval.

Referring to FIG. 7A, then a determination for information updates received via wireless communication portion 121 (FIG. 1) may be performed in a step 710.

Then if it is determined information updates have been received via wireless communication in step 710, in a step 712 wireless communication portion 121 (FIG. 1) communicates information updates to media processor portion 126 (FIG. 1) for processing. Media processor portion 126 (FIG. 1) receives and processes information updates and stores processed updates in memory portion 117 (FIG. 1). As an example, advertisement information updates are received wirelessly and processed and stored in memory for later retrieval.

Referring to FIG. 7A, then a determination for adjusting GUI brightness may be performed in a step 714.

Then if it is determined brightness is to be adjusted in step 714, in a step 716 brightness is adjusted.

Media processor portion 126 (FIG. 1) receives and processes brightness information from light sensor portion 116 (FIG. 1). Media processor portion 126 (FIG. 1) modifies the brightness of GUI portion 118 and GUI portion 120. For example, the device may be transferred from a bright environment to a dark environment. Furthermore, the device senses the ambient light change and modifies the brightness of the GUIs accordingly (e.g. less bright).

Referring to FIG. 7A, then a determination for adjusting audio may be performed in a step 718.

Then if it is determined audio is to be adjusted in step 718, in a step 720 audio is adjusted.

Media processor portion 126 (FIG. 1) receives and processes audio information from audio sensor portion 115 (FIG. 1). Media processor portion 126 (FIG. 1) modifies the amplitude of the information presented via speaker portion 122 (FIG. 1) and/or speaker portion 123 (FIG. 1). For example, if the device is transferred from a quiet to a noisy room, the device increases the amplitude of the information presented via the speakers.

Referring to FIG. 7B, then a determination for a security breach is performed in a step 722.

Then if it is determined in step 722 a security breach has occurred, then in a step 724 an alarm is executed and/or the device is disabled.

Media processor portion 126 (FIG. 1) receives and processes location information from location detection portion 125 (FIG. 1). As a result of detecting a security breach, media processor portion 126 (FIG. 1) presents an alarm to speaker portion 122 (FIG. 1) and speaker portion 123 (FIG. 1). Furthermore, media processor portion 126 (FIG. 1) ceases to receive control information from control interface portion 110 (FIG. 1). If there is a wireless connection with a POS, then the POS is notified for an alert. Additional information may be communicated to the POS such as, but not limited to, location of system 100, last activity, last possession, etc.

Referring to FIG. 7B, then a determination for proximity with another device is performed in a step 726.

Then if it is determined in step 726 that the devices is in close proximity to another device, then in a step 728 the device is muted.

Media processor portion 126 (FIG. 1) receives and processes proximity information from proximity sensor portion 112 (FIG. 1). Media processor portion 126 (FIG. 1) mutes audio presented to speaker portion 122 (FIG. 1) and/or speaker portion 123 (FIG. 1).

Referring to FIG. 7B, then a determination for a triggering event is performed in a step 730.

Then if it is determined in step 730 a triggering event has occurred, then in a step 732, information is presented via the GUIs and via the speakers.

Media processor portion 126 (FIG. 1) receives and processes triggering associated information from trigger portion 114 (FIG. 1). Media processor portion 126 (FIG. 1) presents information to GUI portion 118 (FIG. 1), GUI portion 120 (FIG. 1), speaker portion 122 (FIG. 1) and/or speaker portion 123 (FIG. 1). For example, front cover of device may be opened which results in information being presented via GUIs and speakers. As another example, device may detect being placed on a flat surface (e.g. table) resulting in information being presented via GUIs and speakers.

Referring to FIG. 7B, then a determination for selecting play button is performed in a step 734.

Then if it is determined in step 734 play button has been selected, then in a step 736, information is presented via GUIs and speakers.

Media processor portion 126 (FIG. 1) receives and processes play button associated information from control interface portion 110 (FIG. 1). Media processor portion 126 (FIG. 1) presents information to GUI portion 118 (FIG. 1), GUI portion 120 (FIG. 1), speaker portion 122 (FIG. 1) and/or speaker portion 123 (FIG. 1).

Referring to FIG. 7C, then a determination for selecting mute button is performed in a step 738.

Then if it is determined in step 738 mute button has been selected, then in a step 740 information presented via speakers is muted.

Media processor portion 126 (FIG. 1) receives and processes mute button associated information from control interface portion 110 (FIG. 1). Media processor portion 126 (FIG. 1) mutes information presented to speaker portion 122 (FIG. 1) and/or speaker portion 123 (FIG. 1).

Referring to FIG. 7C, then a determination for low power is performed in a step 742.

Then if it is determined in step 742 a low power condition exists, then in a step 744 an indication of lower power is presented to the GUIs and/or speakers.

Media processor portion 126 (FIG. 1) receives and processes an indication of low power from docking port portion 104 (FIG. 1). Media processor portion 126 (FIG. 1) communicates a condition of low power to GUI portion 118 (FIG. 1), GUI portion 120 (FIG. 1), speaker portion 122 (FIG. 1) and/or speaker portion 123 (FIG. 1).

Referring to FIG. 7C, then a determination for exiting flow chart 700 is performed in a step 746.

For a determination of not exiting flow chart 700 in step 746, execution of flow chart 700 transfers to step 704 (FIG. 7A). For a determination of exiting flow chart 700 in step 746 (FIG. 7C), execution of flow chart 700 terminates in a step 748 (FIG. 7C).

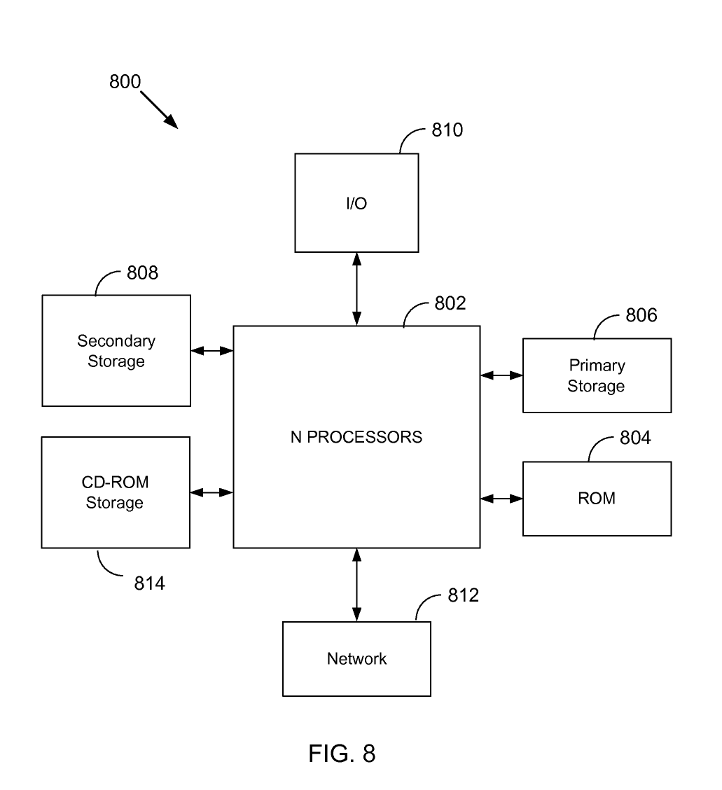

FIG. 8 illustrates a computing system that, when appropriately configured or designed, may serve as a computing system for which the present invention may be embodied.

A computing system 800 includes a quantity of processors 802 (also referred to as central processing units, or CPUs) that may be coupled to storage devices including a primary storage 806 (typically a random access memory, or RAM), a primary storage 804 (typically a read only memory, or ROM). CPU 802 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 804 acts to transfer data and instructions uni-directionally to the CPU and primary storage 806 is used typically to transfer data and instructions in a bi-directional manner. The primary storage devices discussed previously may include any suitable computer-readable media such as those described above. A mass storage device 808 may also be coupled bi-directionally to CPU 802 and provides additional data storage capacity and may include any of the computer-readable media described above. Mass storage device 808 may be used to store programs, data and the like and is typically a secondary storage medium such as a hard disk. It will be appreciated that the information retained within mass storage device 808, may, in appropriate cases, be incorporated in standard fashion as part of primary storage 806 as virtual memory. A specific mass storage device such as a CD-ROM 814 may also pass data uni-directionally to the CPU.

CPU 802 may also be coupled to an interface 810 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 802 optionally may be coupled to an external device such as a database or a computer or telecommunications or internet network using an external connection shown generally as a network 812, which may be implemented as a hardwired or wireless communications link using suitable conventional technologies. With such a connection, the CPU might receive information from the network, or might output information to the network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: servers used for updating system 100 via global network as described with reference to FIG. 1.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

In the above description, an exemplary system enclosure comprised 1 fold. In other embodiments, the system enclosure may comprise a single piece or multiple sides comprising 1 fold or 2 or 3 folds. In some embodiments, the system enclosure may comprise a leather cover. In other embodiments other materials such as, but not limited to, acrylic, plastic, carbon fiber, cloth, or other flexible or solid material may be used. In other embodiments it may also be simply a solid material without a wrap or a type of vacuum formed casing. In other embodiments, the enclosure may comprise a GUI screen from top to bottom with only a frame structure to hold the components together. In some embodiments, the GUI maybe mounted on the outside of a cover and not actually be integrated. In these embodiments, the system may be an add-on device and simpler to manufacture. In other embodiments the enclosure may have a custom design and shape or color, For example, but not limited to, the shape of a beer bottle, can, a plate, a coffee cup, bottle of wine etc. In other embodiments the system may include a touchscreen interface or a digital readout of the bill for the patron. In various other embodiments, the GUI may have a format such as, but not limited to widescreen, standard or extras wide. In some embodiments, the GUI may comprise technologies such as, but not limited to TFT, LED, LCD, STN, OLED and any other new technology. In some embodiments, there may be a protective covering over the GUI to protect it from damage. Non-limiting examples of protective covering comprise glass, acrylic or other transparent material used as a protective covering. In some embodiments the system may be updated through the use of mobile technology such as, but not limited to, 3g, 4g, CDMA or any other competitive mobile technology that transmits data via cellular technology. In some embodiments, the system may send a message through the POS device at the location showing that the patron has prepared his/her payment and is ready to process it. In some embodiments the manufacturing of the product may use a pressed in form fitting technology to insert the GUI into the device. In some embodiments the system may also have built in electronics cables inside to transmit electricity and data internally. In other embodiments, the GUI is an approximate size of the bill. This GUI would be transparent and backlight on the backside allowing the bill to be viewed through the front portion of the GUI and lit by the backlight. Then when the advertisement is played, the transparent GUI turns into a active display. In some embodiments the GUI and processor may provide standard definition, high definition or other resolutions and formats. In some embodiments a dock maybe located on the table of the patron and the media player device located in the dock. In these embodiments, the check presenter is a simple GUI and the playback mechanism is located at the table so when the check presenter is placed into the dock at the table, the advertisements begin to play. Some embodiments may further comprise a signature book or a reviews and ratings guide to the location accessible through the GUI. In some embodiments a camera may record images of the patron as a signature backed with a review of a dish or cocktail. In some embodiments the credit card may trigger the playback of the device. When the patron places the credit card into the small slot provided, the device begins playback.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of presenting advertisements in conjunction with presentation of a bill for goods and/or services according to the present invention will be apparent to those skilled in the art. The invention has been described above by way of illustration, and the specific embodiments disclosed are not intended to limit the invention to the particular forms disclosed. For example, the particular implementation of the connector covers may vary depending upon the particular type connector used. The connector covers described in the foregoing were directed to USB connector implementations; however, similar techniques for other types of connector implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A system comprising:
an electronic display;
a media processor being configured to present information at least comprising an advertisement for an establishment on said electronic display to a patron of the establishment;
a power source being operable to supply an operating power to at least said electronic display and said media processor: and
a check presenter being configured to at least retain said electronic display and a check or bill from the establishment to the patron in which the advertisement is presented on said electronic display to the patron.

2. The system as recited in claim 1, further comprising a speaker being configured to present audio information from said media processor to the patron.

3. The system as recited in claim 1, further comprising a trigger portion being configured to at least signal said media processor to start presenting information to the patron.

4. The system as recited in claim 3, in which said trigger portion signals said media processor upon placement of the check presenter on a table surface.

5. The system as recited in claim 1, further comprising a location detection portion being operable for determining a location of said check presenter.

6. The system as recited in claim 5, further comprising a security portion being configured to receive location information from said location detection portion, comparing said location information to locations within a boundary of the establishment, and signaling said media processor of said check presenter traversing the boundary.

7. The system as recited in claim 1, further comprising a proximity sensor portion being configured to detect other check presenters within a determined distance of said check presenter and to signal said media processor upon said detection to at least affect a presentation of the information.

8. The system as recited in claim 2, further comprising an audio sensor portion being configured to detect a level of ambient audio and signal said media processor to affect a level of the audio presentation at least in part based on the level of ambient audio.

9. The system as recited in claim 1, further comprising a light sensor portion being configured to detect a level of ambient light and signal said media processor to affect a level of the presentation on said electronic display at least in part based on the level of ambient light.

10. The system as recited in claim 1, further comprising a docking port being configured to communicate with said media processor to convey at least the information to be presented.

11. The system as recited in claim 10, in which said docking port is further configured to supply a charging power to said power supply.

12. The system as recited in claim 1, further comprising a control interface portion being configured to communicate with said media processor to at least enable the patron to affect the information presentation.

13. The system as recited in claim 1, further comprising a wireless communication portion being configured to communicate with said media processor to convey at least the information to be presented.

14. A system comprising:
an electronic display;
a media processor being configured to present information at least comprising an advertisement for an establishment on said electronic display to a patron of the establishment;
a speaker being configured to present audio information from said media processor to the patron;
a trigger portion being configured to at least signal said media processor to start presenting information to the patron;
a location detection portion being operable for determining a geographical location;
a security portion being configured to receive location information from said location detection portion, comparing said location information to locations within a boundary of the establishment, and signaling said media processor of said location detection portion traversing the boundary;
a proximity sensor portion being configured to detect other proximity sensor portions within a determined distance of said proximity sensor portion and to signal said media processor upon said detection to at least affect a presentation of the information;
a docking port being configured to communicate with said media processor to convey at least the information to be presented;
a control interface portion being configured to communicate with said media processor to at least enable the patron to affect the information presentation;
a power source being operable to supply an operating power to at least components of the system; and
a check presenter being configured to at least retain said electronic display and a check or bill from the establishment to the patron in which the advertisement is presented on said electronic display to the patron.

15. The system as recited in claim 14, in which said trigger portion signals said media processor upon placement of the check presenter on a table surface.

16. The system as recited in claim 14, further comprising an audio sensor portion being configured to detect a level of ambient audio and signal said media processor to affect a level of the audio presentation at least in part based on the level of ambient audio.

17. The system as recited in claim 14, further comprising a light sensor portion being configured to detect a level of ambient light and signal said media processor to affect a level of the presentation on said electronic display at least in part based on the level of ambient light.

18. The system as recited in claim 14, in which said docking port is further configured to supply a charging power to said power supply.

19. The system as recited in claim 14, further comprising a wireless communication portion being configured to communicate with said media processor to convey at least the information to be presented.

20. A method of operating the system as recited in claim 14, the method comprising the steps of:
receiving the information to be presented to the patron on said docking port;
signaling an alarm upon said location detection portion traversing the boundary of the establishment;
affecting the presentation of the information upon the detection of another proximity sensor portions within the determined distance;
starting the presentation to the patron upon the signaling from the trigger portion; and
affecting the information presentation upon communication from said control interface portion.
